(19) United States
(12) Patent Application Publication
(10) Pub. No.: US 2002/0198856 A1
(43) Pub. Date: Dec. 26, 2002

(54) Minimization of business rules violations

(76) Inventors: Jacob Feldman, Edison, NJ (US); Alexander Korolov, Cliffside Park, NJ (US); Semen Meshcheryakov, Edison, NJ (US); Stanislav Shor, Edison, NJ (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/953,697

(22) Filed: Sep. 12, 2001

Related U.S. Application Data
(60) Provisional application No. 60/313,079, filed on Aug. 16, 2001.
(60) Provisional application No. 60/300,951, filed on Jun. 25, 2001.

(51) Int. Cl. G06N 5/02

(52) U.S. Cl. 706/47

(57) ABSTRACT

A method and apparatus for minimizing violations of rules in a rule-based system is disclosed. In one embodiment, the method and apparatus is implemented with software tools.

The present application claims priority to the following provisional filed applications entitled Minimization of Business Rules Violations, filed on Aug. 16, 2001, serial No. ______; entitled Hybrid Use of Rule and Constraint Engines, filed on Jun. 25, 2001, serial No. 60/300,951; entitled Consistency Validation for Complex Classification Rules, filed on August 16, serial No. ______, all of which are incorporated herein by reference.

### FIELD OF THE INVENTION

The present invention relates generally to the field of expert systems.

### BACKGROUND OF THE INVENTION

Business rules are statements of business policies and procedures that drive day-to-day business activity. Rule-based technology provides the ideal architecture for implementing flexible, easy-to-maintain business rule applications, because such applications keep the rules separate from the application code. Rule-based technology is based on rule engines, well known to those skilled in the art as Rete engines and used by most expert systems since 1982. Specialized rule languages and their supporting rule engines are rapidly becoming a must-have element within e-commerce platforms and B2B/B2C applications.

However, in real-world applications, it is a rare situation where all active rules are satisfied. As a result, practical rules-processing systems seek to find business solutions that satisfy the most important rules, instead of reporting rules violations. Examples of such problems may be found almost in any rule processing system.

Consider, for example, a typical e-business application familiar to any online trader: a portfolio management system. This system contains a rules-processing subsystem that allows a financial guru to specify business rules, such as, for example, “Allocation of Utility stocks should be within 5 percent to 8 percent,” “Do not buy European stocks except from the UK,” and other rules of a similar nature. Such a rules-processing subsystem assists the portfolio manager to keep managed portfolios intact with these rules during securities trading. The rule engine can naturally inform the user about a violation of any rule. What it cannot do is to recommend the best combination of trading orders that can minimize total rules violations. If consideration is given to the relative importance of different rules and some limitations for the rules violation (e.g., “do not violate this rule for more than 3 percent”), a complex optimization problem of potentially unlimited size will be described. This is a pure optimization problem, which cannot be resolved by the rule engine itself.

As another example, consider a typical product configuration application: selection of the best calling plan or origination of the financial loan that fits the customer request in the best possible way. Each product (calling plan or loan) has a set of features and each customer could have its own set of requirements/preferences to the product (e.g., average number of peak minutes or minimal monthly payment). The products themselves and the customer preferences could be expressed in form of rules with different importance. In the real-world situations, usually it is not possible to find the exact match between the available and desirable features. It means some of the product configuration rules will be violated. The objective here is to configure such a product which satisfies the most important customer requirements, or in other words, to minimize the total violation of the configuration rules.

### SUMMARY OF THE INVENTION

A method and apparatus for minimizing violations of rules in a rule-based system is disclosed. In one embodiment, the method and apparatus is implemented with software tools.

### BRIEF DESCRIPTION OF THE DRAWINGS

FIG. 1 is a schematic diagram showing a functional scheme for minimizing rule violations according to one embodiment.

### DETAILED DESCRIPTION

An ability to be violated is an important attribute of any rule. Therefore, one may express the minimization of rule violations as a constraint satisfaction problem. In one embodiment, each rule is associated with one constrained expression that calculates the possible rule violation, as formulated in the following terms. Using the stockbroker example again, specifically:

Entities:

T={T₁, T₂, . . . , Tₜ}−a set of rule templates.

Some examples of the rule templates include:

(a) Allocation of <sector> should be within <min>% and <max>%

(b) Minimum number of <peak/offpeak> minutes should be no less than <min>

Each template specifies a generic business rule with a set of the rule specific parameters.

Rule Instances:

Based on the rule templates, one could create rule instances, defined as shown in the expression

Rⁱⱼ=R(Tᵢ, parⁱⱼ)

created from the template Tᵢ by applying the parameter set parⁱⱼ.

Some examples of rule instances include:

R¹₁=“Allocation of Technology should be within 20.00% and 30.00%” created from the template (a) by applying the parameter set par¹₁={sector=“Technology”, min=20.00, max 30.00}

R¹₂=“Allocation of Utilities should be within 0.00% and 10.00%” created from the template (a) by applying the parameter set par¹₂={sector=“Utilities”, min=0.00, max=10.00}

R²₁=“Minimum number of peak minutes should be no less than 900” created from the template (b) by applying the parameter set par²₁={peak/offpeak=“peak”, min=900}

Each rule instance Rⁱⱼ has a weight wⁱⱼ, which could be considered as a relative “importance” of this rule:

0.0<=wⁱⱼ<=1.0

Rules may be violated. The violation of any rule instance Rⁱⱼ could be expressed in one embodiment as a constrained integer or float expression violationⁱⱼ. In one embodiment, when all violations have been created, the optimization problem may be formulated and solved as shown in the following expression:

Σ_{i,j}(wⁱⱼ*violationⁱⱼ)→min

with constraints

violationⁱⱼ<max_violationⁱⱼ for all i,j.

In one embodiment, the proposed problem definition and resolution may be accomplished using Exigen software products Exigen Rules™ and Exigen Constrainer™. In one embodiment, all rules could be created based on the rule templates.

In one embodiment, one may use the Exigen Template Editor to create new or modify existing rule templates. The templates are in one embodiment presented in XML. The presentation part of the template is intuitive and does not require any special knowledge. In most situations, the end user does not touch the templates, and deals only with the rule instances. To express rule violations, in one embodiment one can use Exigen Constrainer™ symbolic constrained expressions directly in the rule language.

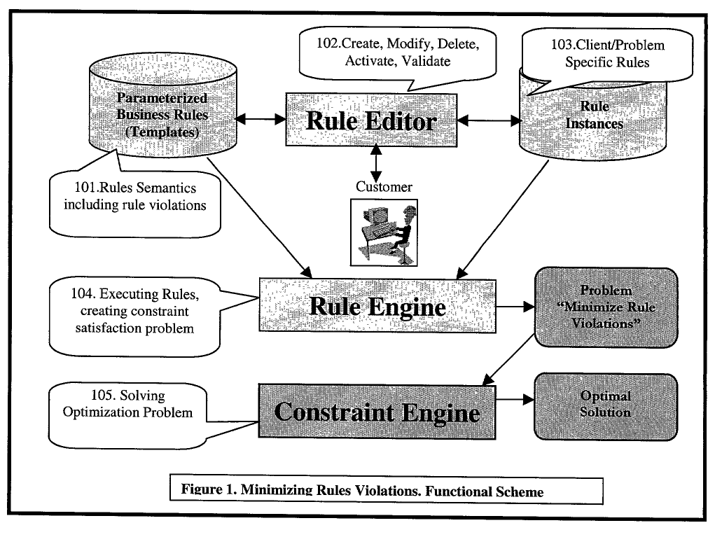

Because the semantics of the rules are in one embodiment presented in the rule templates, the definition of the rules violation is independent of rule parameters. A functional scheme according to one embodiment is presented in FIG. 1. A rule engine 104 creates a constraint satisfaction problem. Then a constraint engine 105 solves the constraint satisfaction problem.

Thus, the proposed approach and the supporting tools according to one embodiment allow users to solve the practical problem of the typical rule processing system: how to minimize rule violations. A key advantage of this approach is the ability to find the best practical solution in situations where not all active rules may be satisfied at the same time.

It will be clear to a person knowing the art that the use of minimization of rules violation is not limited to stock trading and calling plans, but has vast other uses; for example, including but not limited to financial planning (both personal, corporate and government), insurance industry, telecom industry (e.g. for priority planning, data routing in bottleneck or emergency situations), power utilities, transport systems, merchandise distribution systems, etc.

The processes and embodiments as described above can be stored on a machine-readable medium as instructions. The machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). The device or machine-readable medium may include a solid state memory device and/or a rotating magnetic or optical disk. The device or machine-readable medium may be distributed when partitions of instructions have been separated into different machines, such as across an interconnection of computers.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method comprising:
providing for expression of a minimization of rule violations as a constraint satisfaction problem; and
providing for solution of the constraint satisfaction problem.

2. The method of claim 1, wherein expression of a minimization of rule violations as a constraint satisfaction problem is based on a weight of a rule.

3. The method of claim 1, wherein a rule is associated with a constrained variable.

4. The method of claim 1, wherein a rule is based on a rule template.

5. The method of claim 4, wherein the rule template is expressed in XML.

6. The method of claim 1, wherein a definition of a rule violation is independent of a rule parameter.

7. A machine-readable medium that provides instructions which, when executed by a machine, cause the machine to perform operations comprising:
expressing a minimization of rule violations as a constraint satisfaction problem; and
solving the constraint satisfaction problem.

8. The machine-readable medium of claim 7, wherein expressing a minimization of rule violations as a constraint satisfaction problem is based on a weight of a rule.

9. The machine-readable medium of claim 7, wherein a rule is associated with a constrained variable.

10. The machine-readable medium of claim 7, wherein a rule is based on a rule template.

11. The machine-readable medium of claim 10, wherein the rule template is expressed in XML.

12. The machine-readable medium of claim 7, wherein a definition of a rule violation is independent of a rule parameter.

13. An apparatus comprising:
a rule engine to provide for finding a combination of rules having a minimum number of rule violations by creating an optimization problem; and
a constraint engine coupled with the rule engine, the constraint engine to provide for finding a combination of rules having a minimum number of rule violations by solving the optimization problem.

14. The apparatus of claim 13, wherein finding the combination of rules having the minimum number of rule violations is based on a weight of a rule.

15. The apparatus of claim 13, wherein finding the combination of rules having the minimum number of rule violations is expressed as a constraint satisfaction problem.

16. The apparatus of claim 13, wherein a rule is associated with a constrained variable.

17. The apparatus of claim 13, wherein a rule is based on a rule template.

18. The apparatus of claim 17, wherein the rule template is expressed in XML.

19. The apparatus of claim 13, wherein a definition of a rule violation is independent of a rule parameter.
